(19) United States
(12) Patent Application Publication
(10) Pub. No.: US 2001/0036176 A1
(43) Pub. Date: Nov. 1, 2001

(54) Apparatus and method for telephony service interface to software switch controller

(76) Inventor: Gregory D. Girard, Beverly, MA (US)

Correspondence Address: ERIC L. PRAHL, Fish & Richardson P.C., 225 Franklin Street, Boston, MA, 02110-2804, US

(21) Appl. No.: 09/796,934

(22) Filed: Feb. 28, 2001

Related U.S. Application Data
(60) Provisional application No. 60/185,549, filed on Feb. 28, 2000.

(51) Int. Cl. H04L 12/66

(52) U.S. Cl. 370/352; 370/522

(57) ABSTRACT

An apparatus and method achieve a level of telephony application functionality commensurate with TDM (Time Division Multiplex) device interfaces used in legacy PSTN (Public Switched Telephone Network) voice and facsimile telephony applications. The apparatus and method rely upon the architectural model embraced by VOP (Voice Over Packet) carrier network network standards, and include network elements and a protocol framework. The apparatus and method build upon the SIP model to incorporate essential telephony application functions previously only available using a PSTN infrastructure. The telephony service interface incorporates mechanisms for both call control and media control operations. Together, the apparatus and method transition the legacy PSTN telephony application services model to a data-centric model by exploiting the switching and digital signal processing capacity of a software switch controller and a media gateway defined as core network elements in the VOP carrier network

Under 35 U.S.C. §119(e)(1), this application claims benefit of prior U.S. Provisional Application No. 60/185,549, entitled “Apparatus And Method For Telephony Service Interface To Software Switch Controller,” filed Feb. 28, 2000, and which is incorporated herein by reference.

### TECHNICAL FIELD

This invention relates to telephony, and more particularly to telephony applications, telephony protocols, and telephony networks.

### BACKGROUND

In both the PSTN (Public Switched Telephone Network) and the VOP (voice-over-packet) CARRIER NETWORK, a TELEPHONY APPLICATION SERVER includes the computing element in which service logic executes. The term TELEPHONY APPLICATION PROGRAM is here used in the most general sense. It should be understood as referring to any intelligent entity that requires the ability to create, delete, modify, or monitor network connections as part of its task to render a service. As a result, the term TELEPHONY APPLICATION PROGRAM may refer to, for example, an entity that renders a calling card service, an 800 number translation network feature, a Centrex feature set, a voice mail service, or perhaps a subscriber-oriented “find-me” service. Basic applications such as dial tone service or call-forwarding are often described as network features; however in this discussion, no distinction is made between an application or feature, and services of either classification shall be referred to generically as TELEPHONY APPLICATION PROGRAMS.

In general, application logic in a TELEPHONY APPLICATION SERVER hosting the TELEPHONY APPLICATION PROGRAMS makes requests to local or remote devices in order to create calls, answer calls, route calls or perform a range of digital signal processing telephony operations. In the PSTN, most application servers physically incorporate a telephony switching matrix under local software control while other variants of the telephony application server interact directly with a PSTN switch's internal time division multiplex (TDM) switching matrix utilizing an Intelligent Network (IN) interface.

In prior systems, functionality can be achieved using either/both PSTN application server interfacing techniques. PSTN telephony application server interfaces (TDM or IN) control a host switching matrix directly or indirectly through a software interface, so as to manage calls terminating into that switching matrix in the bearer plane. It should be mentioned that not all telephony applications require a bearer path. The typical PSTN telephony application answers incoming calls or originates its own calls, managing each call control operation. Intelligent Network interfaces are typically constrained to supporting only the simplest of call control application tasks. Essentially, the telephony application presents an array of computer-controlled telephone interfaces to the network.

A TDM switching fabric (or “switching matrix”) is typically connected to the PSTN using T1/E1 or Primary Rate Interface. All of these interfacing technologies carry bearer channel content and some degree of signaling information. Typically Signaling System #7 is utilized to establish the signaling pathway necessary to acquire Dialed Number Information Service packets for the purpose of identifying to whom the call was originally directed. Most TDM interfaces are equipped with some DSP capability. Various DSP algorithms are used to detect and measure DTMF tones or measure voice energy levels. Digital signal processors are typically available as an accessory hardware component for TDM products. A bearer channel in the TDM switching matrix may be routed through a DSP resource designed to recognize DTMF digit waveforms appearing in bearer channel content. When the DSP resource detects a specific DTMF digit, it generates an event that is propagated to a telephony application instance that may be listening for DTMF digits.

### SUMMARY

An apparatus is constructed comprising a telephony application server, a software switch controller, and media gateways that are under control of the software switch controller. A dependent method is described such that the elements of this apparatus operate in an interdependent fashion to enable voice and facsimile telephony software application programs running on the telephony application server to achieve a level of telephony application functionality commensurate with Time Division Multiplex device interfaces used in legacy PSTN voice and facsimile telephony applications.

The telephony application programs communicate with the software switch controller and media gateways under its control through an IP data network according to a fully-specified telephony service interface. The telephony service interface includes a protocol framework used to establish a normalized relationship between two or more actual or virtual telephone endpoints, both of which reside in the IP connectivity domain. This relationship requires that both media and signaling/control pathways pass through the IP data network and exploit the software switch controller and media gateways under its control as a virtualized connectivity resource capable of explicitly or implicitly invoking well known call control and media control functions defined for that endpoint relationship. Any IP telephony endpoint that complies with the exact protocol framework is considered to be normalized and as a result may make full use of the call control and media control functions defined for that endpoint relationship.

A telephony application session occurs when one of the participating normalized endpoints in the call terminates on a telephony application server and that endpoint is under the control of a telephony application program. Based upon IETF RFC 2543 on “Session Initiation Protocol”, this telephony service utilizes the SIP signaling pathway established for initial call setup. Summarily, a SIP-based telephony service interface is established in which both signaling and bearer pathways pass through a data network in accordance with a normalized telephone endpoint model. Telephone features are supported utilizing existing voice-over-packet network elements as shared resources capable of simultaneously managing call control and media control operations.

In general, in one aspect, the invention features a system including a telephony application server; a software switch controller; and one or more media gateways that are under control of the software switch controller. A telephony application program running on the telephony application server communicates with the software switch controller and the one or more media gateways that are under control of the software switch controller through a QOS IP network according to a fully-specified telephony service interface.

Preferred embodiments may include one or more of the following features. The telephony service interface includes features that are supported utilizing existing VOP carrier network elements as shared resources capable of simultaneously supporting signaling plane operations and bearer plane operations. The server, the controller, and the one or more media gateways operate in an interdependent fashion to enable voice and facsimile telephony software application programs running on the telephony application server to achieve a level of functionality commensurate with Time Division Multiplex device interfaces used in legacy PSTN voice and facsimile telephony applications. The system also includes media and signaling/control pathways that pass through the QOS IP network to exploit the software switch controller and the one or more media gateways that are under control of the software switch controller as a virtualized connectivity resource capable of explicitly or implicitly invoking well known call control and media control functions defined for that endpoint relationship as described by telephony service interface. Also, there exist signaling plane operations that are a subset of the telephony service interface and that are also supported using a SIP signaling pathway established for initial call setup.

In general, in another aspect, the invention features a telephony service interface which implements a protocol framework used to establish a normalized relationship between two or more actual or virtual telephone endpoints, both of which reside in an IP connectivity domain.

Preferred embodiments may include one or more of the following features. The telephony service interface also establishes both signaling and bearer pathways through a QOS IP network in accordance with a normalized telephone endpoint model. Any actual or virtual telephone endpoint that complies with the exact protocol framework implemented by the telephony service interface is considered to be “normalized” and as a result may make full use of the well known call control and media control functions defined for that endpoint relationship as described by the telephony service interface. A telephony application session occurs when one of the participating normalized endpoints in the call terminates on a telephony application server and is under control of a telephony application program.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 depicts a telephony application server fitting into the basic architecture of a VOP carrier network architecture;

FIG. 2 depicts the apparatus as comprised of three interdependent network elements communicating through a QOS IP NETWORK[11] using standardized protocols; and

FIG. 3 depicts a protocol framework used to establish a normalized relationship between two or more actual or virtual telephone endpoints, both of which reside in the IP connectivity domain.

Like reference symbols in the various drawings indicate like elements.

With respect to major network elements and the network clouds, the figures provide solid connector lines to denote physical network interfaces whereas dotted lines denote message-passing protocol relationships in which protocol data units are exchanged through the QOS IP NETWORK or other telecommunications network elements.

With respect to network sub-elements, the figures provide solid connector lines to denote physical or direct programmatic relationships between hardware and/or software components, which may or may not be based upon message-passing protocol relationships.

### DETAILED DESCRIPTION

Definitions

This section contains a description of major system elements and terms and figure conventions referenced in this disclosure. Inasmuch as the telecommunications industry contains a variety of views regarding what comprises these elements, the definitions provided herein are set forth as applicable to the discussions herein.

Telephony Application Session

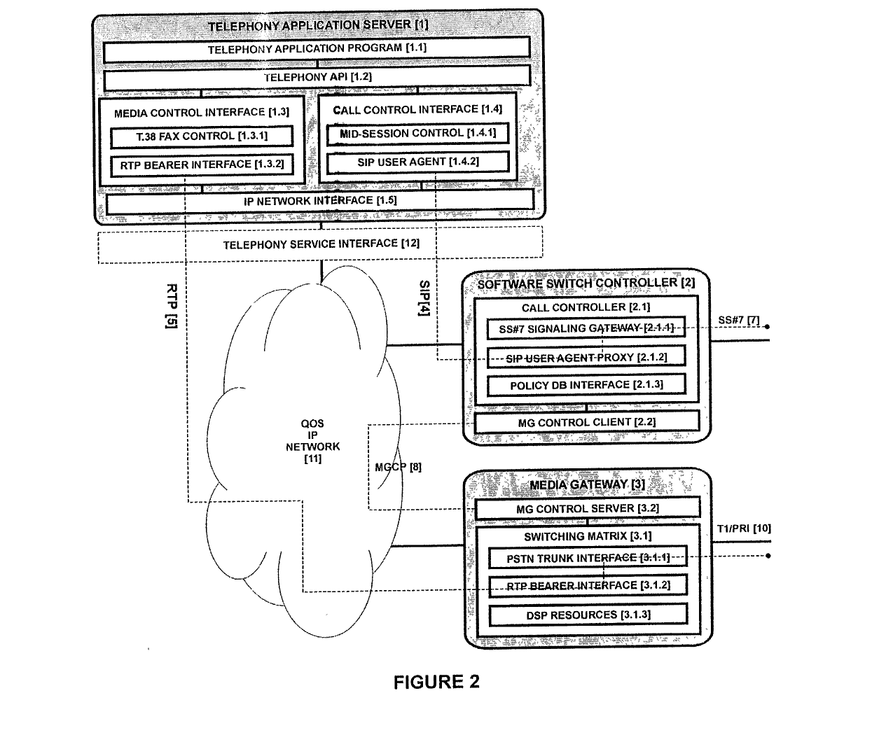

With regard to FIG. 2, a TELEPHONY APPLICATION SESSION is a telephony session or “connection” comprised of at least two call participants in which at least one participant includes a “computer-controlled” telephone (that may be equipped with fax capabilities) under the control of a TELEPHONY APPLICATION PROGRAM[1.1]. Each TELEPHONY APPLICATION SESSION may control one or more of these “computer-controlled” telephones and has some degree of information management resources at its disposal that enable it to transform, store, retrieve, and search information that is relevant to the intended purpose of a particular TELEPHONY APPLICATION SESSION. Such information typically includes as recorded voice messages, text messages, subscriber contact lists, and various databases. The TELEPHONY APPLICATION PROGRAM presents narrow ranges of options to the calling party by playing pre-recorded voice prompts in the form of “voice menus” or “voice dialogs.” That caller selects the desired option or next action by entering DTMF digits that are recognized as user input stimulus by the TELEPHONY APPLICATION SESSION. Alternate implementations may support user a input stimulus modality in which or uses a voice command is recognized by the TELEPHONY APPLICATION PROGRAM through its use of a speech recognition system resource.

Telephony Application Server[1]

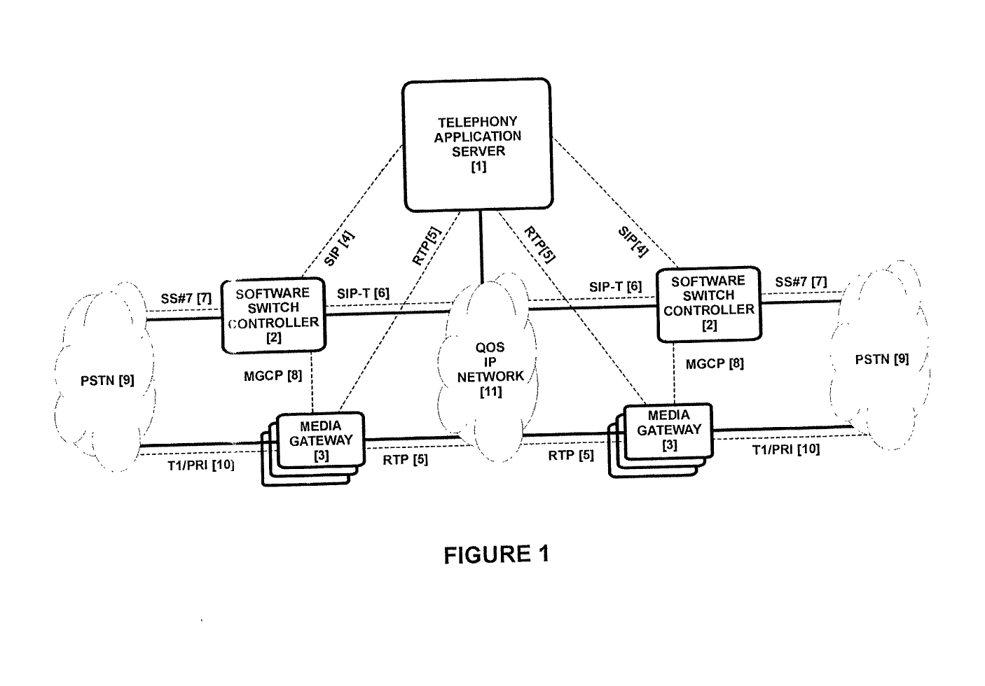

With regard to FIG. 1, a TELEPHONY APPLICATION SERVER[1] includes a network element containing hardware and software components required to host one or more TELEPHONY APPLICATION PROGRAMS[1.1]. Functions conceptually as an array of “computer controlled” telephones in which the TELEPHONY APPLICATION PROGRAM replaces a human operator as the controlling entity in the form of a TELEPHONY APPLICATION SESSION.

Telephony Application Program[1.1]

With regard to FIG. 2, a TELEPHONY APPLICATION PROGRAM[1.1] includes a computer software program that runs on the TELEPHONY APPLICATION SERVER[1] and conceptually replaces a human operator (as a “robot”) to respond to user input stimulus from the caller or network events associated with the SIP-TELEPHONY SERVICE INTERFACE[12]. The TELEPHONY APPLICATION PROGRAM includes the software embodiment of the service logic supported by a particular type of TELEPHONY APPLICATION SESSION. When a TELEPHONY APPLICATION SERVER answers an incoming call, it usually is required to execute a particular TELEPHONY APPLICATION PROGRAM so as to fulfill requirements that the caller receive a particular service.

Telephony API[1.2]

With regard to FIG. 2, a TELEPHONY API[1.2] includes an abstract software programmer interface at the presentation layer containing twenty-eight functions that are used by the TELEPHONY APPLICATION PROGRAM[1.1] to create and maintain a TELEPHONY APPLICATION SESSION in accordance with the requirements of the TELEPHONY SERVICE INTEFACE[12]. Specifically for the purposes of this disclosure, the TELEPHONY API includes an abstract of composite of media control functions, call control functions, and all adjunct functions required by the TELEPHONY APPLICATION PROGRAM[1.1] to support a TELEPHONY APPLICATION SESSION.

Media Control Interface[1.3]

A MEDIA CONTROL INTERFACE[1.3] includes a software control interface for media control subsystem, combining control for T.38 FAX CONTROL[1.3.1] functions and RTP BEARER INTERFACE[1.3.2] functions into a composite set of control operations as described for the BEARER PLANE OPERATIONS[12.2].

T.38 Fax Control[1.3.1]

A T.38 FAX CONTROL[1.3.1] includes a software subsystem that may include hardware component necessary to support fax communication using RTP media streams established by the RTP BEARER CHANNEL INTERFACE[1.3.2] and according to Study Group 8 of the ITU-T (Jun. 1998) “Recommendation T.38: Procedures for Real-Time Group 3 Facsimile Communication Over IP Networks,” International Telecommunications Union.

RTP Bearer Channel Interface[1.3.2]

An RTP BEARER CHANNEL INTERFACE[1.3.2] includes a software subsystem (that usually includes adjunct hardware component) necessary to terminate telephony session bearer paths as RTP media streams according to IETF RFC 2889 (Dec. 1999) on RTP: A Transport Protocol for Real-Time Applications. In most implementations, a physical RTP network termination device containing embedded control software and a co-processor are installed into the TELEPHONY APPLICATION SERVER[1]. However the embodiment of the disclosed apparatus does not preclude the use of a specialized adjunct “media server” slave device under control of TELEPHONY APPLICATION SERVER if it is able to terminate RTP media streams in the telephone network bearer plane.

Call Control Interface[1.4]

A CALL CONTROL INTERFACE[1.4] includes a software control interface for call control subsystem. Combines control for MID-SESSION CONTROL[1.4.1] functions and SIP USER AGENT[1.4.2] functions into a composite set of control operations as described for the SIGNALING PLANE OPERATIONS[12.1].

Mid-Session Control[1.4.1]

A MID-SESSION CONTROL[1.4.1] includes a software subsystem that provides CALL CONTROL INTERFACE[1.4] with ability to support specialized end-to-end massage passing between TELEPHONY APPLICATION SESSION and caller. Such message-passing is required to support features not directly supported by SIP[4], and thus a mid-session control protocol may be built over the SIP[4] signaling pathway used by the TELEPHONY APPLICATION SESSION. This subsystem interfaces the SIP USER AGENT[1.4.2] in that it utilizes the SIP INFO method or other methods, such as XML-encoding (extensible markup language), to transparently (to the SIP call session) “tunnel” mid-session control messages through the SIP signaling pathway established at time of call setup.

SIP User Agent[1.4.2]

A SIP USER AGENT[1.4.2] includes a software subsystem defined by RFC for SIP[4] that contains both client and server elements, and includes the principal telephone endpoint abstract used in the SIP[4] call model. The SIP USER AGENT may not only represent a signaling endpoint that may be invited into a SIP call session, but it may also invite other SIP endpoints (SIP USER AGENTS) into the SIP call session by presenting such connection requests to SOFTWARE SWITCH CONTROLLER[2]. By making requests to the SOFTWARE SWITCH CONTROLLER, the SIP USER AGENT may create a SIP call session that includes any two endpoints addressable by that SOFTWARE SWITCH CONTROLLER[2].

IP Network Interface[1.5]

An IP NETWORK INTERFACE[1.5] includes a software and hardware subsystem necessary to create data connections through a QOS IP NETWORK[11] for the purpose of terminating telephone calls according to the TELEPHONY SERVICE INTERFACE[12]. The disclosed apparatus may be constructed using a single IP NETWORK INTERFACE to support both SIP[4] signaling pathways and RTP[5] bearer pathways, or alternately separate IP NETWORK INTERFACE elements may be created for each pathway, according to specific implementation requirements.

Software Switch Controller[2]

With regard to FIG. 1, a SOFTWARE SWITCH CONTROLLER[2] includes a network element that contains a software program responsible for routing calls, invoking services, and performing other interconnection operations in accordance with programmable policies typically stored in a policy database. The behavior of the SOFTWARE SWITCH CONTROLLER as applied to specific call paths may be programmed by modifying the policies stored in the policy database. The SOFTWARE SWITCH CONTROLLER utilizes one or more MEDIA GATEWAYS[3] according to a master-slave relationship to create the “bearer plane” network interconnections that carry the actual encoded voice content. It utilizes an SS#7 SIGNALING GATEWAY[2.1.1] (described below, and with regard to FIG. 2) to translate between its internal signaling format and, with regard to FIG. 1, the PSTN[9] signaling formats if it is configured to interface the PSTN.

Call Controller[2.1]

With regard to FIG. 2, a CALL CONTROLLER[2.1] includes a software subsystem of the SOFTWARE SWITCH CONTROLLER that responds to incoming connection requests according to a specific policy that is stored in a database and accessed using the POLICY DB INTERFACE[2.1.3]. Connection requests may be presented to the CALL CONTROLLER from the PSTN[9] through the SS#7 SIGNALING GATEWAY[2.1.1] or the SIP USER AGENT PROXY[2.1.2]. If the connection request results in the creation of a call session between two telephones, the CALL CONTROLLER will utilized the MG CONTROL CLIENT[2.2] to establish a bearer path between the two telephones, using the MEDIA GATEWAY[3] or MEDIA GATEWAYS[3] that are most appropriate to maintain the connection. The CALL CONTROLLER may create call sessions between any two or more telephones residing within any of the connectivity domains (e.g. IP, PSTN) that it is designed to interface. The disclosed apparatus describes on IP and PSTN[9] connectivity domains in its preferred embodiment; however the use of these examples should not be construed as a limitation on the design of the apparatus.

SS#7 Signaling Gateway[2.1.1]

A SS#7 SIGNALING GATEWAY[2.1.1] includes a software and hardware subsystem necessary to convert PSTN[9] Signaling System #7 protocol transactions into an equivalent abstract representations that may be understood by the CALL CONTROLLER[2.1]. The SS#7 SIGNALING GATEWAY operates bi-directionally for signaling transactions that are (1) initiated internally by the CALL CONTROLLER[2.1] and must be translated into Signaling System #7 transactions to be effective in the PSTN, and (2) that are initiated in the PSTN[9] and must be translated into a format understood internally by the CALL CONTROLLER[2.1.2]

SIP User Agent Proxy[2.1.2]

An SIP USER AGENT PROXY[2.1.2] includes a software subsystem necessary to provide an abstract representation of SIP telephone endpoints, a function that includes the conversion of SIP[4] protocol transactions into an equivalent abstract representations that may be understood by the CALL CONTROLLER[2.1]. The SIP USER AGENT PROXY operates bi-directionally for signaling transactions that are (1) initiated internally by the CALL CONTROLLER[2.1] and must be translated into SIP[4] transactions to be effective in establishing call sessions in the QOS IP NETWORK[11], and (2) that are initiated according to SIP[4] in the QOS IP NETWORK[11] and must be translated into a format understood internally by the CALL CONTROLLER[2.1].

Policy DB Interface[2.1.3]

A POLICY DB INTERFACE[2.1.3] includes a software subsystem used by CALL CONTROLLER[2.1] to access connection policies stored in a policy database (not shown in this disclosure). The connection policies are abstract data representations of the control logic necessary to route calls, invoke services, and perform other interconnection operations that define the behavior of the SOFTWARE SWITCH CONTROLLER[2] as applied to specific call paths.

MG CONTROL CLIENT[2.2]

An MG CONTROL CLIENT[2.2] includes a software subsystem that serves as the SOFTWARE SWITCH CONTROLLER[2] control interface to send vendor-specific MGCP[8] commands to the MG CONTROL SERVER[3.2] for the purpose of applying bearer plane resources as required to establish a call session initiated by the CALL CONTROLLER[2.1]. The MG CONTROL CLIENT provides an abstract representation of the client portion of an underlying MGCP[8].

Media Gateway[3]

With regard to FIG. 1, a MEDIA GATEWAY[3] includes a network element containing hardware and software components whose purpose is to provide programmable switching fabric capable of maintaining telephone interconnections across multiple telephony connectivity domains, such as PSTN, voice-over-IP or voice-over-ATM. The disclosed apparatus describes on IP and PSTN[9] connectivity domains in its preferred embodiment; however the use of these examples should not be construed as a limitation on the design of the apparatus. A MEDIA GATEWAY suitable for the disclosed apparatus must provide the ability to apply DSP algorithms to media pathways that they interconnect. The MEDIA GATEWAY includes the primary switching element in VoP network architectures.

Switching Matrix[3.1]

With regard to FIG. 2, a SWITCHING MATRIX[3.1] includes a software and hardware subsystem necessary to physically interconnect bearer connections whose call session endpoints may reside within any of the connectivity domains (e.g. IP, PSTN) that it is designed to interface. The SWITCHING MATRIX utilizes the PSTN[9] TRUNK INTERFACE[3.1.1] to establish bearer connections to call session endpoints in the PSTN[9] and uses the RTP BEARER INTERFACE[3.1.2] to establish bearer connections to call session endpoints in the QOS IP NETWORK[11]. The SWITCHING MATRIX creates and deletes bearer paths under software control and may apply DSP RESOURCES[3.1.3] to any bearer path that passes through it, regardless of the location of the call session endpoint. The disclosed apparatus describes on IP and PSTN[9] connectivity domains in its preferred embodiment; however the use of these examples should not be construed as a limitation on the design of the apparatus.

PSTN[9] Trunk Interface[3.1.]

A PSTN[9] TRUNK INTERFACE[3.1.1] includes a software and hardware subsystem necessary to interconnect T1/PRI[10] interfaces into the SWITCHING MATRIX[3.1]. The PSTN[9] TRUNK INTERFACE is responsible (1) for converting T1/PRI[10] bearer channel content into a packetized media stream format suitable for manipulation by the SWITCHING MATRIX[3.1 ] in one direction and (2) for converting a packetized media streams into T1/PRI[10] format suitable for PSTN[9] transmission in the other direction.

RTP Bearer Channel Interface[3.1.2]

A RTP BEARER CHANNEL INTERFACE[3.1.2] includes a software and hardware subsystem necessary to interconnect RTP[5] bearer channel connections into the SWITCHING MATRIX[3.1]. The RTP BEARER CHANNEL INTERFACE is responsible (1) for converting RTP[5] bearer channel content into format suitable for manipulation by the SWITCHING MATRIX[3.1] in one direction and (2) for converting SWITCHING MATRIX[3.1] bearer channel content into a format suitable for RTP[5] transmission in the other direction.

DSP Resources[3.1.3]

DSP RESOURCES[3.1.3] comprise a software and hardware subsystem that enables the SWITCHING MATRIX[3.1] to apply DSP algorithms to bearer channels passing through for the purpose of (1) transmitting faxes, (2) receiving faxes, (3) tone and voice signal transformation, and (4) tone and voice signal detection. Signal transformation processes include algorithms that alter the signal as it passes through the SWITCHING MATRIX, e.g. noise compensation, format conversion (u-law to PCM), or insertion of DTMF tones. Signal detection processes do not alter the signal passing through the MG, but instead monitor the signal for a particular type of event, e.g. DTMF tones or speech onset. A fully-compliant DSP RESOURCES subsystem for the disclosed apparatus shall support real-time facsimile transmission between a facsimile modem operating at a PSTN[9] network endpoint and an IP endpoint operating according to T.38. The MEDIA GATEWAY also supports connections between two IP endpoints according to T.38 by simply passing through the T.38 fax information. Summarily, the DSP RESOURCES should support the following telephony application session-level operations as they apply to signal processing in the bearer plane:

Detect DTMF digits on voice pathway from endpoint

Generate DTMF digit tones on voice pathway to endpoint

Detect tones on voice pathway from endpoint

Generate tones on voice pathway to endpoint

Enable/disable noise cancellation for voice pathway from endpoint

Detect voice onset/offset for voice pathway from endpoint

The disclosed apparatus may incorporate equivalent support for the above operations by installing DSP devices and control software into the MEDIA CONTROL INTERFACE[1.3]; however this configuration is much less desirable in terms of system cost and performance.

MG Control Server[3.2]

An MG CONTROL SERVER[3.2] includes a software subsystem that serves as the MEDIA GATEWAY[3] control interface to receive vendor-specific MGCP[8] commands from the MG CONTROL CLIENT[2.2] for the purpose of applying bearer plane resources as required to establish a call session initiated by the CALL CONTROLLER[2.1]. The MG CONTROL SERVER includes the server portion of an underlying MGCP[8].

SIP[4]

With regard to FIG. 1, SIP refers explicitly to RFC 2543 on Session Initiation Protocol. RFC 2543 contains a full description of SIP. As specifically applied to the disclosed apparatus and method, SIP is used as a call control and signaling protocol that has the ability to interoperate seamlessly across multiple telephony connectivity domains. SIP is a suitable protocol for signaling between SOFTWARE SWITCH CONTROLLERS[2] (for network interoperability) and for signaling between telephones. The disclosed method uses SIP as the principal call control protocol choice for a VoP network interface to a TELEPHONY APPLICATION SERVER[1]. SIP resides exclusively in the signaling and control layer of the network and interacts with the underlying network switching fabric layer (comprised of MEDIA GATEWAYS[3]) primarily as a consequence of call control operations mediated by a SOFTWARE SWITCH CONTROLLER[2]. Specific extensions to SIP are required by the disclosed method, most of which have been proposed through the IETF. While the disclosed method is explicit in the functions that it requires, the exact procedures used to satisfy these requirements are left as implementation-dependent options. For certain requirements, there may exist more than a single suitable mechanism, the specific selection of which is not architecturally relevant and may depend upon telecommunications carrier network deployment requirements.

RTP[5]

RTP refers explicitly to RFC 1889 on RTP: A Transport Protocol for Real-Time Applications. RFC 1889 contains a full description of RTP. As specifically applied to the disclosed apparatus and method, RTP is used as a means to create and maintain bearer channel connections through the QOS IP NETWORK[11]. The disclosed methods uses RTP as the principal bearer channel connection mechanism for a VoP network interface to a TELEPHONY APPLICATION SERVER[1]. RTP resides exclusively in the bearer plane of the network and interconnects directly to the RTP BEARER INTERFACE[3.1.2] of the MEDIA GATEWAY[3]. Specific adjunct protocols that run over RTP are required by the disclosed method, most of which have been proposed through the IETF and ITU-T. While the disclosed method is explicit in the functions that it requires, there are four functions that are left as implementation-dependent options. For certain requirements, there may exist more than a single suitable mechanism, the specific selection of which is not architecturally relevant and may depend upon telecommunications carrier network deployment requirements.

SIP-T[6]

SIP-T[6] refers to Internet Draft on SIP for Telephones (SIP-T): Context and Architectures, an extension to SIP that enables tunneling of SS#7[7] messages through the SIP signaling pathway for the purpose of preserving PSTN[9] signaling information as is passed through the QOS IP Network[11]. This protocol notation may refer to any SIP[4] extension or derivative used for communication between SOFTWARE SWITCH CONTROLLERS[2].

SS#7[7]

SS#7 refers to Signaling System #7 and any of its international variants used as the primary signaling protocol for the PSTN[9].

MGCP[8]

MGCP refers to any one of a family of client-server device control protocols used to control a MEDIA GATEWAY[3] network element. The client-server elements may be collapsed into a simple software control interface without affecting the design of the disclosed apparatus.

PSTN[9]

PSTN refers to the Public Switched Telephone Network.

T1/PRI[10]

T1/PRI refers to T1 or Primary Rate Interface digital trunk interfaces used in the PSTN[9] and based upon circuit-switched TDM technology. Both of these interfacing technologies carry bearer channel content and some degree of signaling information.

QOS IP Network[11]

QOS IP Network[11] refers to a quality of service packet network operating according to the internet protocol at the level that it interfaces the TELEPHONY APPLICATION SERVER[1] according to the TELEPHONY SERVICE INTERFACE[12]. In this network, a means is provided to ensure that both signaling and bearer channel connections can be maintain with a quality of service (latency, bandwidth, security) necessary to support real-time, full-duplex telephone calls.

VOP Carrier Network

VOP CARRIER NETWORK refers to converged “voice-over-packet” local exchange carrier telecommunications network in which core switching capabilities are provided using a transmission infrastructure constructed from a combination of SOFTWARE SWITCH CONTROLLERS[2], MEDIA GATEWAYS[3], and a QOS IP NETWORK[11] rather than legacy PSTN[9] Class 4 tandem switches. Such networks may also utilize edge switches that use a similar complement of SOFTWARE SWITCH CONTROLLERS[2] and MEDIA GATEWAYS[3] rather than legacy PSTN[9] Class 5 switches. The VOP CARRIER NETWORK includes a hybrid network that may utilize lower layer voice-over-packet transmission elements such as ATM, and it retains the requirement to interface seamlessly to the legacy PSTN[9] equipment the perspective of dialing access. The disclosed apparatus and method require only that at least one SOFTWARE SWITCH CONTROLLER[2], one MEDIA GATEWAY[3], and the QOS IP NETWORK[11] system elements are present in order for the TELEPHONY APPLICATION SERVER[1] to support TELEPHONY APPLICATION PROGRAMS[1.1] operating in accordance with the TELEPHONY SERVICE INTERFACE[12].

Telephony Service Interface[12]

TELEPHONY SERVICE INTERFACE[12] refers to protocol framework used to establish a normalized relationship between telephone endpoints both of which reside in the IP connectivity domain. This relationship requires that both media and signaling/control pathways pass through a QOS IP NETWORK[11] and exploit the SOFTWARE SWITCH CONTROLLER[2] (and MEDIA GATEWAYS[3] under its control) as a virtualized connectivity resource capable of explicitly or implicitly invoking well known call control and media control functions defined for that endpoint relationship. Any IP telephony endpoint that complies with the exact protocol framework is considered to be “normalized” and as a result may make full use of the well known call control and media control functions defined for that endpoint relationship. The functions defined for TELEPHONY SERVICE INTERFACE consist of SIGNALING PLANE OPERATIONS[12.1] and BEARER PLANE OPERATIONS[12.2] that may both be applied to the same call session. A TELEPHONY APPLICATION SESSION occurs when one of the participating endpoints in the call terminates on a TELEPHONY APPLICATION SERVER[1] and that endpoint is under the control of a TELEPHONY APPLICATION PROGRAM[1.1].

Signaling Plane Operations[12.1]

For all SIGNALING PLANE OPERATIONS, the first endpoint mentioned is presumed to terminate on the CALL CONTROL INTERFACE[1.4] of the TELEPHONY APPLICATION SERVER[1] (in the IP connectivity domain) whereas the second endpoint may reside in any connectivity domain.

CONNECT—endpoint connects to another endpoint to create call session or to add call participant

DISCONNECT—endpoint disconnects from call session

DETECT BUSY—endpoint detects busy condition during attempt to connect to another endpoint

3-WAY CALLING—call participant added to two-party call results in fully-meshed 3-way conference

CALLING/CALLED PARTY—endpoint identifies dialing number of original calling and called party

REASON FOR REDIRECT—identify identifies reason for call redirection

HOLD/RESUME—endpoint puts call participant on hold; resumes after hold operation

DIRECT TRANSFER—endpoint invokes transfer from existing other endpoint to new endpoint

SUPERVISED TRANSFER—endpoint invokes third party transfer while not directly in call session

MWI NOTIFICATION—activate or deactivate telephone message-waiting indication at endpoint

CALL PICKUP/PARK—endpoint transfers inbound call to new endpoint before answering

CALLER ID—endpoint receives detailed directory information with name of calling party

DETECT FUNCTION KEY—endpoint receives function key press event invoked by another endpoint

GENERATE FUNCTION KEY—endpoint sends function key press to another endpoint

Bearer Plane Operations[12.2]

For all BEARER PLANE OPERATIONS, the first endpoint mentioned is presumed to terminate on the MEDIA CONTROL INTERFACE[1.3] of the TELEPHONY APPLICATION SERVER[1] (in the IP connectivity domain) whereas the second endpoint may reside in any connectivity domain.

PLAY VOICE PROMPT—endpoint transmits voice to another endpoint

RECORD VOICE PROMPT—endpoint receives voice from another endpoint

DETECT DTMF DIGITS—endpoint receives DTMF digits from another endpoint

GENERATE DTMF DIGITS—endpoint sends DTMF digits to another endpoint

DETECT ON/OFF HOOK—endpoint receives on/off hook event from endpoint

DETECT HOOK FLASH—endpoint receives hook flash event from endpoint

DETECT VOICE ONSET—endpoint receive voice onset event from endpoint

DETECT VOICE OFFSET—endpoint receives voice offset event from endpoint

DETECT FAX TONES—endpoint receives fax tone events from endpoint

TRANSMIT FAX—endpoint transmits fax to endpoint

RECEIVE FAX—endpoint receives fax from endpoint

Apparatus and Method

With regard to FIG. 1, a representative TELEPHONY APPLICATION SERVER[1] fits into the basic architecture of a VOP CARRIER NETWORK architecture. As the primary switching element in the VOP CARRIER NETWORK, a MEDIA GATEWAY may be used in conjunction with PSTN[9] switching technologies. A MEDIA GATEWAY does not contain all of the logic necessary to route calls or invoke subscriber services. A SOFTWARE SWITCH CONTROLLER[2] contains the logic necessary to route calls, invoke services, and perform other interconnection operations in accordance with programmable policies stored in a database. A SOFTWARE SWITCH CONTROLLER[2] utilizes one or more MEDIA GATEWAYS[3] to create the necessary network interconnections and employs signaling gateways to translate between its internal signaling format and the specific signaling formats used by connectivity domains it is configured to support. In this way, the VOP CARRIER NETWORK isolates network call routing logic from switching infrastructure so that services residing ultimately in the signaling/control plane of the network (e.g. dial-tone, long-distance calling, voice mail) may be transparently deployed across a range of switching infrastructure technologies.

Instead of embedding a switching matrix in an application server and controlling it as a local resource, a SOFTWARE SWITCH CONTROLLER[2] acts as an intermediary to ultimately transmit messages to a MEDIA GATEWAY[3]. Those messages instruct the MEDIA GATEWAY[3] to perform operations directly analogous to those performed using local call control and DSP resources in the legacy PSTN[9] model. A data-oriented bearer channel connection between a TELEPHONY APPLICATION SERVER[1] and a MEDIA GATEWAY[3] may be established for the purpose of playing voice prompts, transmitting facsimiles, or recording voice content as required by the application. There is no local switching fabric incorporated into the physical a TELEPHONY APPLICATION SERVER[1]; thus bearer channel connections are created, deleted, and interconnected through the switching matrix in the MEDIA GATEWAY[3] under the control of the SOFTWARE SWITCH CONTROLLER[2], relying on existing network infrastructure resources.

FIG. 2 depicts the apparatus as comprised of three interdependent network elements communicating through a QOS IP NETWORK[11] using standardized protocols to the extent possible. A generalized architecture is provided for each network element based upon architectural approaches used to build VOP CARRIER NETWORKS. The detailed functionality of the SOFTWARE SWITCH CONTROLLER[2] and MEDIA GATEWAY[3] elements of this network architecture are known in the art. The design of the TELEPHONY APPLICATION SERVER[1] warrants further discussion.

The TELEPHONY APPLICATION SERVER[1] embodies five logical elements the work together such that it may present a collection of “service points” to the VOP CARRIER NETWORK. Each of these elements is more fully described in the DEFINITIONS section, so it follows that attention be turned to operational dynamics. The TELEPHONY APPLICATION SERVER[1] is describe one of three elements that comprise the apparatus, and it is not fully functional as a standalone entity. While it can terminate call sessions as a virtual telephone endpoint, it cannot directly connect callers together or apply DSP algorithms to media pathways. Other than acting as a telephone endpoint, it relies upon the SOFTWARE SWITCH CONTROLLER[2] for call control functionality and the MEDIA GATEWAYS[3] under control the SOFTWARE SWITCH CONTROLLER[2] for media control functionality.

Aside from its core responsibilities as the principal controlling and signaling element of the VOP CARRIER NETWORK, the SOFTWARE SWITCH CONTROLLER[2] is utilized by the TELEPHONY APPLICATION SERVER[1] as a call control resource. In a reciprocal fashion, the TELEPHONY APPLICATION SERVER[1] is utilized by the SOFTWARE SWITCH CONTROLLER[2]. When the SOFTWARE SWITCH CONTROLLER[2] receives a request to establish a call session between two endpoints, certain connection policies may result in a requirement that SOFTWARE SWITCH CONTROLLER[2] direct that call session so that it connects to a service point.

For example, if the SOFTWARE SWITCH CONTROLLER[2] attempts to complete a call to an endpoint and a busy signal is returned, the SOFTWARE SWITCH CONTROLLER[2] may redirect that call to a voice call-answering TELEPHONY APPLICATION PROGRAM[1.1] running on a TELEPHONY APPLICATION SERVER[1]. In this case the SOFTWARE SWITCH CONTROLLER[2] creates a call session between the original calling endpoint and a virtual endpoint on the TELEPHONY APPLICATION SERVER[1]. As part of this call control operations, the SOFTWARE SWITCH CONTROLLER[2] passes the dialing number of the calling party, the dialing number original called party, and a “reason code” indicating that the called party endpoint returned a busy signal, thus informing the receiving TELEPHONY APPLICATION SERVER[1] as to the reason for transfer. The TELEPHONY APPLICATION SERVER[1] would have been pre-configured to execute a voice call-answering TELEPHONY APPLICATION PROGRAM[1.1] each time it received a call that had originally been intended to reach the called party dialing number.

When the voice call-answering TELEPHONY APPLICATION PROGRAM[1.1] answers the telephone, it may play a prompt and ask the calling party if they would like to attempt to “find” the called party. The TELEPHONY APPLICATION PROGRAM[1.1 ] may then wait to detect a DTMF digit press from the calling endpoint to ascertain the desired action. If the desired action was to leave a message, the TELEPHONY APPLICATION PROGRAM[1.1] would the play a “beep” prompt and begin recording voice transmitted from the calling party endpoint and save it in a message store.

If the calling party selected to “find” the called party, voice call-answering TELEPHONY APPLICATION PROGRAM[1.1] would execute a “find-me” service in which it attempted to locate the called party by dialing other telephones where that person might be found. In this case, the called person would have pre-configured a list of alternate telephone numbers. The TELEPHONY APPLICATION PROGRAM[1.1] would examine this list of numbers and send messages to the SOFTWARE SWITCH CONTROLLER[2] requesting that it attempt to create connections to telephone identified by the numbers. Functioning as a call control resource to the TELEPHONY APPLICATION SERVER[1], the SOFTWARE SWITCH CONTROLLER[2] would attempt to create the connections, passing back all signaling events to the virtual telephone endpoints being used by the TELEPHONY APPLICATION PROGRAM[1.1] to represent the outgoing calls. If the TELEPHONY APPLICATION PROGRAM[1.1] detected an answer event for one of these calls, it would disconnect all other call attempts in progress by sending requests to the SOFTWARE SWITCH CONTROLLER[2]. In the same way, it would send a request to the SOFTWARE SWITCH CONTROLLER[2] to transfer the original calling party endpoint to the new endpoint where the called party answered the call.

Aside from its core responsibilities as the principal switching fabric element of the VOP CARRIER NETWORK, the MEDIA GATEWAY[3] is utilized by the TELEPHONY APPLICATION SERVER[1] as a media control resource both directly and indirectly. In the examples above, each time the TELEPHONY APPLICATION PROGRAM[1.1] initiated a call session by sending a message to the SOFTWARE SWITCH CONTROLLER[2], it was necessary for the SOFTWARE SWITCH CONTROLLER[2] to send commands to the MEDIA GATEWAY[3] to establish the bearer path for the call. In addition the DTMF detection by the TELEPHONY APPLICATION PROGRAM[1.1] was possible because the DSP RESOURCES[3.1.3] on the MEDIA GATEWAY[3] were examining the bearer paths for DTMF digit waveforms. When a DTMF digit waveform is detected, the MEDIA GATEWAY[3] inserts a data message into the RTP bearer path indicating that the digit was detected. The same approach may be utilized by the MEDIA GATEWAY[3] to indicate a number of other bearer-related events such as the onset or offset of voice on the bearer path, or the occurrence of telephone on/off hook events.

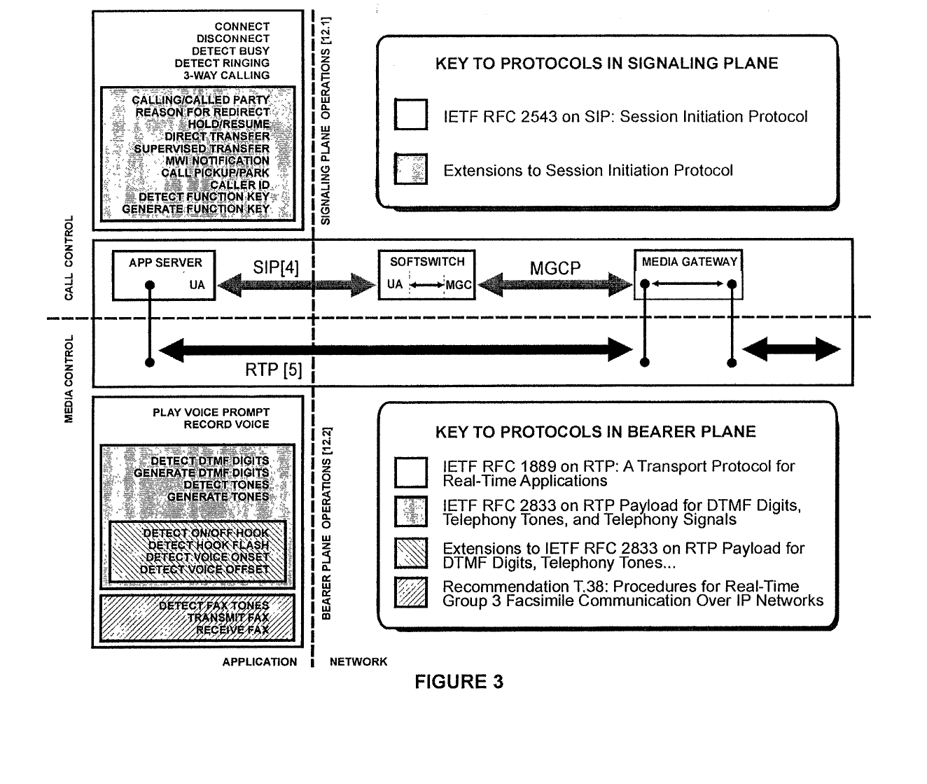

The interface between the TELEPHONY APPLICATION SERVER[1] and the VOP CARRIER NETWORK is shown as the TELEPHONY SERVICES INTERFACE[12]. FIG. 3 depicts the TELEPHONY SERVICE INTERFACE[12] as a protocol framework used to establish a normalized relationship between two or more actual or virtual telephone endpoints, both of which reside in the IP connectivity domain. According to the described TELEPHONY SERVICE INTERFACE[12], both signaling and bearer pathways pass through QOS IP NETWORK[11] in accordance with this normalized telephone endpoint model. FIG. 3 shows interface functions divided into BEARER PLANE OPERATIONS[12.2] and SIGNALING PLANE OPERATIONS[12.1].

Any actual or virtual telephone endpoint that complies with the exact protocol framework described by TELEPHONY SERVICE INTERFACE[12] is considered to be “normalized” and as a result may make full use of the well known call control and media control functions defined for that endpoint relationship as described by TELEPHONY SERVICE INTERFACE[12]. A TELEPHONY APPLICATION SESSION[1.1] occurs when one of the participating normalized endpoints in the call terminates on a TELEPHONY APPLICATION SERVER[1] and is under the control of a TELEPHONY APPLICATION PROGRAM[1.1].

A number of embodiments of the invention have been described. Nevertheless, it will be understood that various modifications may be made without departing from the spirit and scope of the invention. Accordingly, other embodiments are within the scope of the following claims.

What is claimed is:

1. A communication system comprising:
a telephony application server;
a software switch controller; and
one or more media gateways that are under control of the software switch controller, wherein a telephony application program running on the telephony application server communicates with the software switch controller and the one or more media gateways that are under control of the software switch controller through a QOS IP network according to a fully-specified telephony service interface.

2. The system of claim 1 wherein the telephony service interface includes features that are supported utilizing existing VOP carrier network elements as shared resources capable of simultaneously supporting signaling plane operations and bearer plane operations.

3. The system of claim 1 wherein the server, the controller, and the one or more media gateways operate in an interdependent fashion to enable voice and facsimile telephony software application programs running on the telephony application server to achieve a level of functionality commensurate with Time Division Multiplex device interfaces used in legacy PSTN voice and facsimile telephony applications.

4. The system of claim 1 including media and signaling/control pathways that pass through the QOS IP network to exploit the software switch controller and said one or more media gateways that are under control of the software switch controller as a virtualized connectivity resource capable of explicitly or implicitly invoking well known call control and media control functions defined for that endpoint relationship as described by telephony service interface.

5. The system, of claim 1 wherein there exist signaling plane operations that are a subset of the telephony service interface and wherein said signaling plane operations are supported using a SIP signaling pathway established for initial call setup.

6. A telephony service interface which implements a protocol framework used to establish a normalized relationship between two or more actual or virtual telephone endpoints, both of which reside in an IP connectivity domain.

7. The telephony service interface of claim 6 which also establishes both signaling and bearer pathways through a QOS IP network in accordance with a normalized telephone endpoint model.

8. The telephony service interface of claim 6 wherein any actual or virtual telephone endpoint that complies with the exact protocol framework implemented by the telephony service interface is considered to be “normalized” and as a result may make full use of the well known call control and media control functions defined for that endpoint relationship as described by the telephony service interface.

9. The telephony service interface of claim 6 wherein a telephony application session occurs when one of the participating normalized endpoints in the call terminates on a telephony application server and is under control of a telephony application program.
